(19) United States
(12) Patent Application Publication
(10) Pub. No.: US 2014/0086555 A1
(43) Pub. Date: Mar. 27, 2014

(54) MEDIA SCENE PLAYING SYSTEM, METHOD AND RECORDING MEDIUM THEREOF

(71) Applicant: INSTITUTE FOR INFORMATION INDUSTRY, Taipei City (TW)

(72) Inventors: Chia-Hsiang CHANG, Taipei City (TW); Emery JOU, Taipei City (TW); Jing-Fung CHEN, New Taipei City (TW); Pei-Wen HUANG, Taipei City (TW)

(73) Assignee: INSTITUTE FOR INFORMATION INDUSTRY, Taipei City (TW)

(21) Appl. No.: 13/712,374

(22) Filed: Dec. 12, 2012

(30) Foreign Application Priority Data
Sep. 21, 2012 (TW) 101134755

(51) Int. Cl. H04N 5/76

(52) U.S. Cl. CPC H04N 5/76
USPC 386/241

(57) ABSTRACT

A media scene playing system, method and a recording medium thereof are provided. The system includes a media providing module, an input module, and a media retrieval module. The media providing module is used for providing media data and scene description information corresponding thereto. The input module is used for inputting navigation data. The media retrieval module then compares the navigation data with acquired scene description information to find a scene period matching the navigation data, so as to retrieve scene section media corresponding to the scene period from the media data and play the scene section media.

### CROSS-REFERENCE TO RELATED APPLICATION

This application claims the benefit of Taiwan Patent Application No. 101134755, filed on Sep. 21, 2012, which is hereby incorporated by reference for all purposes as if fully set forth herein.

### BACKGROUND OF THE INVENTION

1. Field of Invention

The present invention relates to a media retrieval system and method, and more particularly to a media retrieval system and method for acquiring a demanded media frame based on scene description data.

2. Related Art

In the prior art, media data is usually played in a linear manner. Image playing software provides a timeline of playing the media data correspondingly. During use, positions on the timeline can be clicked or a slider on the timeline can be dragged, so as to determine an image playing interval. However, the precision of dragging a slider depends on the length of a timeline, and the precision of dragging a slider also affects the precision of positioning a timepoint of a demanded image. Generally speaking, when the timeline is longer, the precision of dragging a slider becomes higher. Therefore, if a user intends to acquire a targeted image or voice from the media data, manual timeline control operations are essential to position a slider at the timepoint of a demanded image, thereby playing the demanded image.

### SUMMARY OF THE INVENTION

To solve the problems above, the present invention discloses a media scene playing system and method for retrieving and playing demanded scene section media by using auxiliary data for describing a scene as the reference for playing media.

The media scene playing system disclosed in the present invention includes a media providing module, an input module, and a media retrieval module.

The media providing module is used for providing media data and scene description information corresponding thereto. The input module is used for inputting navigation data. The media retrieval module is used for comparing the navigation data with each piece of scene description information to acquire at least one scene period matching the navigation data, so as to retrieve at least one piece of scene section media corresponding to the at least one scene period from the media data and play the scene section media.

In the media scene playing method disclosed in the present invention, a media providing module provides media data and at least one piece of scene description data corresponding thereto, next a media retrieval module compares each piece of scene description data with reference to navigation data to find at least one piece of target scene description data matching the navigation data, and then the media retrieval module retrieves a target media frame corresponding to the target scene description data from the media data.

The present invention also discloses a recording medium that stores a program code readable by an electronic device. When an electronic device reads the program code, a media scene playing method is executed. The method is as discussed above.

In the present invention, first, by means of targeted retrieval of media frames, a user finds a demanded video scene within a relatively short time. Secondly, by means of targeted retrieval of media frames, the operation on media data by a user is not limited by the length of a timeline, and the precision of acquiring demanded media data is enhanced, thereby avoiding the operational trouble that it is difficult for a user to drag a slider to a demanded point. Thirdly, by means of targeted retrieval of media frames, a user can acquire demanded media frames once for all to form self-generated media, so that not only the customization media operation that satisfies the demand of the user is formed, but also the operational complexity for the user is reduced.

### BRIEF DESCRIPTION OF THE DRAWINGS

The present invention will become more fully understood from the detailed description given herein below for illustration only, and thus are not limitative of the present invention, and wherein:

FIG. 1 shows a media scene playing system according to an embodiment of the present invention;

FIG. 2 is a first detailed schematic structural view of a media scene playing system according to an embodiment of the present invention;

FIG. 3 is a second detailed schematic structural view of a media scene playing system according to an embodiment of the present invention;

FIG. 4 is a third detailed schematic structural view of a media scene playing system according to an embodiment of the present invention;

FIG. 5 is a fourth detailed schematic structural view of a media scene playing system according to an embodiment of the present invention;

FIG. 6 is a fifth detailed schematic structural view of a media scene playing system according to an embodiment of the present invention;

FIG. 7 is a schematic flow chart of a media scene playing method according to an embodiment of the present invention;

FIG. 8 to FIG. 12 are detailed schematic flow charts of the media scene playing method according to the embodiment of the present invention;

FIG. 13 is a schematic view of media levels according to an embodiment of the present invention;

FIG. 14 is a schematic view of correspondence between scene description data and media frames according to an embodiment of the present invention;

FIG. 15 is another schematic view of correspondence between scene description data and media frames according to an embodiment of the present invention; and

FIG. 16 is a schematic view of a media playing tree structure according to an embodiment of the present invention.

### DETAILED DESCRIPTION OF THE INVENTION

The embodiments of the present invention are illustrated below in detail with reference to the accompanying drawings.

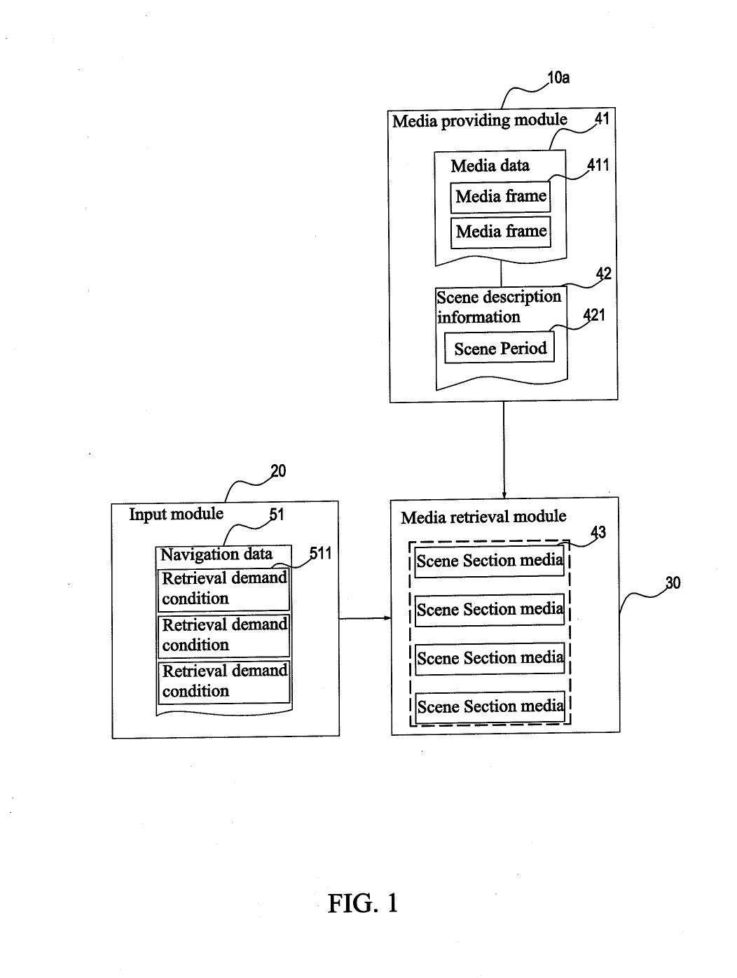

FIG. 1 shows a media scene playing system according to an embodiment of the present invention. The system is applied to a device, apparatus or system with a media playing capability, and the configuration form is not limited. The media scene playing system includes a media providing module 10a, an input module 20, and a media retrieval module 30.

The media providing module 10a is used for providing media data 41 and more than one piece of scene description information 42 corresponding to the media data 41. The media providing module 10a refers to hardware or a combination of more than one form of a unit, component, device, apparatus, and system with a media providing capability that combines software and hardware.

The scene description information 42 is annotation data for annotating the media data 41 or further for annotating media frames 411 included in the media data 41, for example, explanatory data such as brief description, playing duration and title of the playing content of the media data 41.

The input module 20 is used for a user to input navigation data 51, and refers to a data input interface for a user to input data, where the presentation end of the interface depends on the demands of designers, and is not limited.

The media data 41 includes multiple media frames 411 of different contents. For example, when the media data 41 is image data, the image data means image frames having more than one of contents such as targets, scenes and characters. For example, when the media data 41 is voice data, the voice data means voice frames having more than one of contents such as high pitch, low pitch, speeches and music.

The navigation data 51 refers to a retrieval demand condition 511 input by a user when the user intends to retrieve a specific scene interval from the media data 41. For example, the media data 41 is recorded images of a basketball game, a user inputs a retrieval demand condition 511 involving scoring pictures of his favorite players or scoring pictures of three-point shots of all players in a game or scoring pictures of three-point shots of his favorite players and the like. Further, for example, the media data 41 is music data such as an opera, a user inputs a retrieval demand condition 511 involving solos of a female protagonist of the opera or absolute music portion performance and the like.

The media retrieval module 30 is formed of software, hardware or software and hardware, for example, application soft executed by an arithmetic processor, a chip, an integrated circuit (IC) or further firmware that runs in combination with a chip or an IC, which is not limited herein and depends on the demands of designers.

The media retrieval module 30 acquires the media data 41 and the scene description information 42 provided by the media providing module 10a, and acquires the navigation data 51 from the input module 20. The media retrieval module 30 compares the retrieval demand condition 511 of the navigation data 51 and each piece of scene description information 42 to acquire more than one scene period 421 matching the navigation data, and then retrieves all scene section media 43 corresponding to the scene period 421 from the acquired media data 41. The manner of acquiring the scene period 421 is illustrated with the following examples, without being limited thereto:

(1) The scene description information 42 records a plurality of scene playing durations, and the retrieval demand conditions 511 of the navigation data 51 include more than one demand timepoint. The media retrieval module 30 matches these demand timepoints and the scene playing durations to acquire scene periods 421 that meet the demands.

(2) The scene description information 42 includes a plurality of scene description instructions and playing durations corresponding to the scene description instructions. The retrieval demand conditions 511 of the navigation data 51 include more than one piece of scene designation information. The scene designation information refers to the instruction of a demanded scene of a user. The media retrieval module 30 matches each piece of scene designation information and the scene description instruction to acquire the demanded scene periods 421 from all the playing durations.

However, the navigation data 51 may include more than the two types of retrieval demand condition 511, and may also include multiple different retrieval demand conditions 511. The media retrieval module 30 retrieves multiple periods of scene section media 43 from the media data 41 according to the retrieval demand conditions 511. The media retrieval module 30 may directly retrieve video/audio intervals from the media data 41, or retrieve media frames 411 corresponding to the scene periods 421 from the media data 41 and combine the media frames into the scene section media 43.

The media retrieval module 30 may construct one or more pieces of self-generated media with the retrieved pieces of scene section media 43 according to similar rules such as a playing sequence, the media frames 411, playing durations of the scene section media 43 in the media data 41, the sequence of retrieval demand conditions 511. Or, furthermore, a media playing tree structure is constructed depending on the data dependence relationships of the retrieval demand conditions 511 or the type of data attributes. However, an interface of the input module 20 also presents an input field of the media playing tree structure, and the user merely inputs the retrieval demand conditions 511 in the fields according to the data dependence relationships of retrieval demand conditions 511 or the types of the data attributes, which is used as a reference for retrieval and classification of the media frames 411 by the media retrieval module 30.

However, the media providing module 10a also provides a plurality of pieces of media data 41, provides scene description information 42 corresponding to each piece of media data 41, and provides the media data 41 and the scene description information 42 to the media retrieval module 30 together. When inputting the navigation data 51 by means of the input module 20, the user may set different retrieval demand conditions 511 for each piece of media data 41 or set a retrieval demand condition 511 for all the media data 41, which depends on demands of the user. The media retrieval module 30 compares relevant scene description information 42 according to the navigation data 51 to find the scene periods 421, and then retrieves the scene section media 43 from the media data 41 according to the scene periods 421.

Subsequently, the media retrieval module 30 can be designed to construct a playing media that meets the demand of the user with the scene section media 43 or even a group of media frames 411 formed of the scene section media 43.

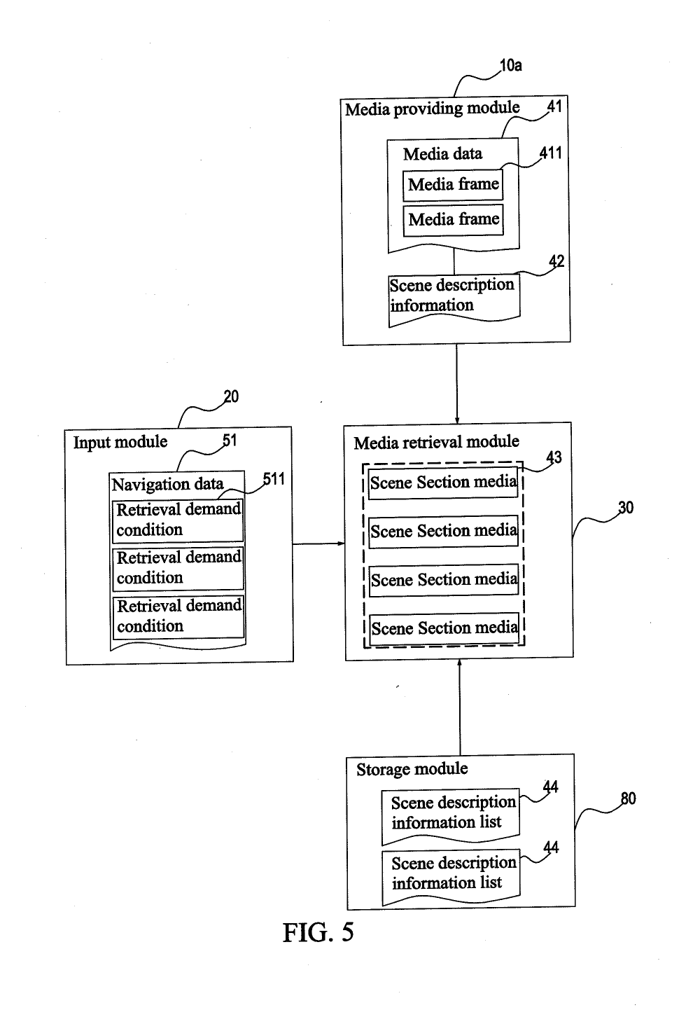

However, the media retrieval module 30 can store retrieved results such as the scene section media 43, the group of media frames 411, the scene periods 421, the media playing tree structure, and the playing media in a storage module 80 (as shown in FIG. 5) for use by the media retrieval module 30 during a next retrieval operation. Furthermore, the playing media constructed through the media retrieval operation can be directly selected and played by a playing module in the system.

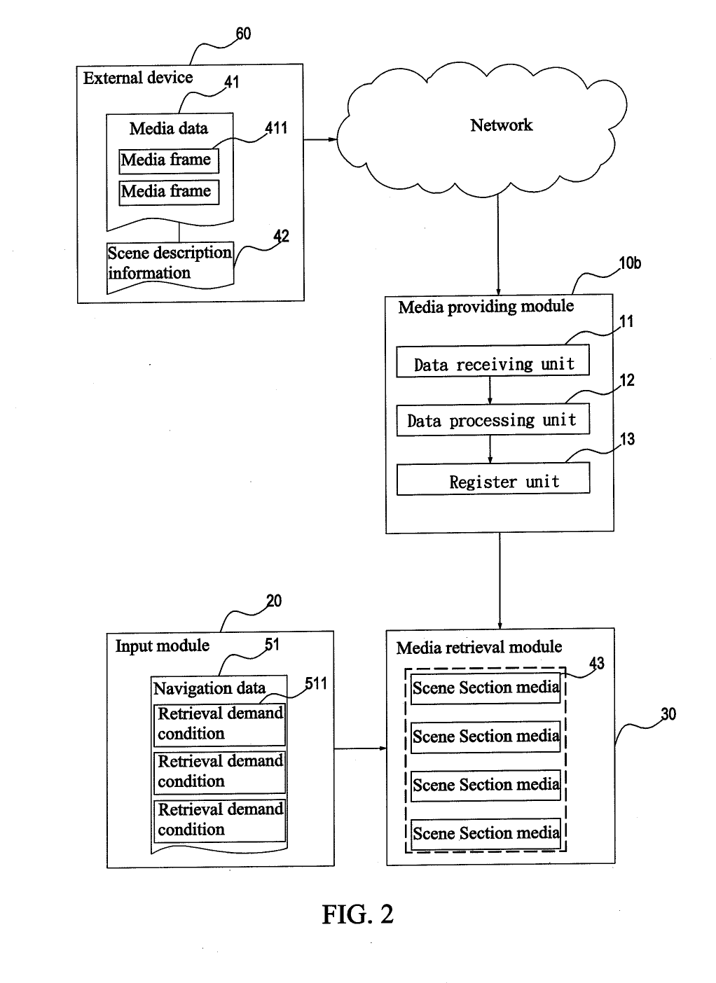

FIG. 2 is a first detailed schematic structural view of a media scene playing system according to an embodiment of the present invention. In this embodiment, a media providing module 10b includes a data receiving unit 11 and a data processing unit 12. The data receiving unit 11 does not store the media data 41 and the scene description information 42, but acquires the media data 41 and the scene description information 42 through connecting to an external device 60 or a network, and provides the acquired media data 41 and scene description information 42 to the media retrieval module 30. The acquired media data 41 may be stream media or an integral video/audio data.

When the media data 41 is stream media, the data processing unit 12 directly transmits the received media frame 411 or media interval to the media retrieval module 30, so that the media retrieval module 30 performs the media retrieval action according to the retrieved data. If the media data 41 is an integral video/audio data, the data processing unit 12 stores the received interval data in a register unit 13, and then provides the media data 41 to the media retrieval module 30 after finishing receiving the media data 41.

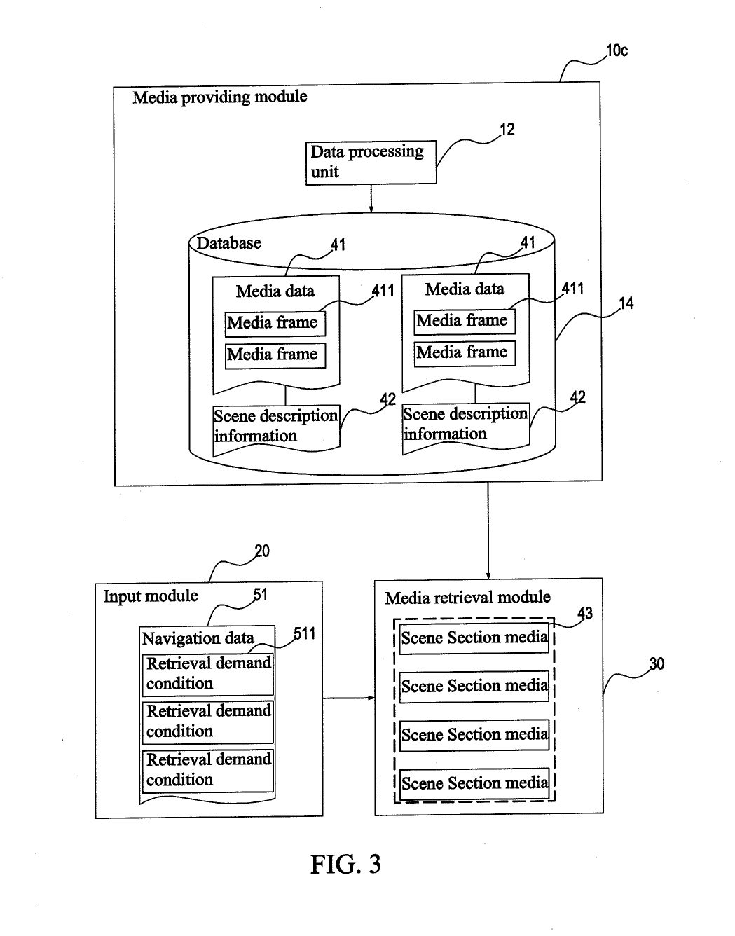

FIG. 3 is a second detailed schematic structural view according to a media scene playing system according to an embodiment of the present invention. Different from FIG. 2, a media providing module 10c is a database module, and has a database 14 and a data processing unit 12. The database 14 is used for storing the media data 41 and the scene description information 42. When a user designates the media data 41 with an input module 20 or a relevant control interface (not shown) in the system, the data processing unit 12 retrieves the media data 41 designated by the user and the scene description information 42 corresponding thereto from the database 14, and provides the media data 41 and the scene description information 42 to the media retrieval module 30.

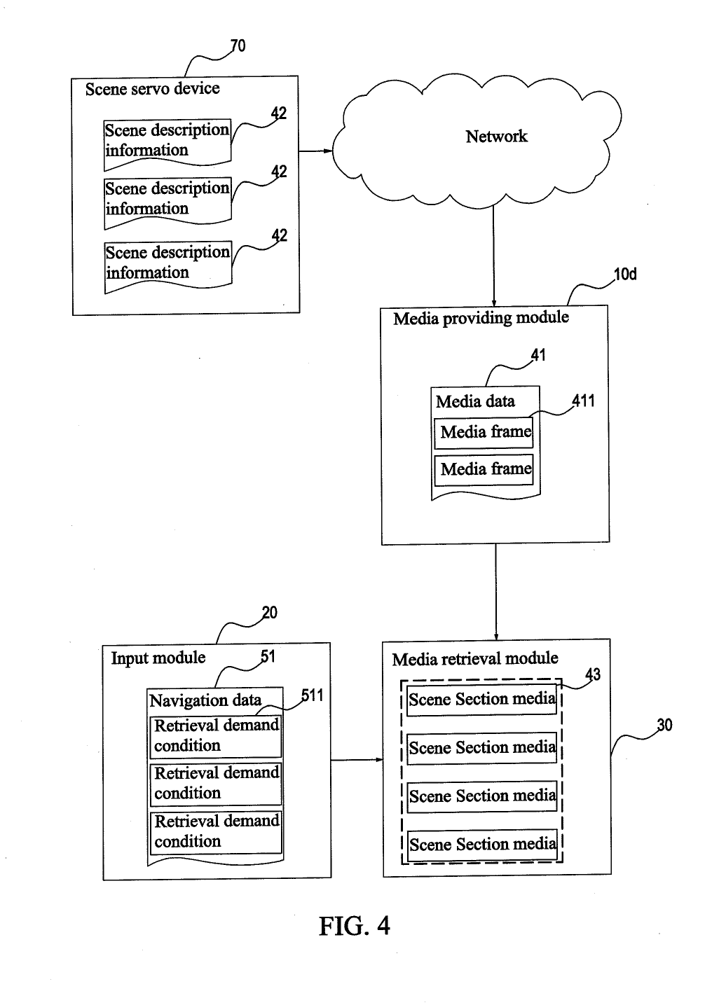

FIG. 4 is a third detailed schematic structural view of a media scene playing system according to an embodiment of the present invention. Different from the foregoing embodiments, a media providing module 10d is connected to a scene servo device 70. The scene servo device 70 stores one or more pieces of scene description information 42. When providing the media data 41, the media providing module 10 acquires all scene description information 42 corresponding to the media data 41 from the scene servo device 70, and provides the media data 41 and the scene description information 42 corresponding thereto to the media retrieval module 30.

FIG. 5 is a fourth detailed schematic structural view of a media scene playing system according to an embodiment of the present invention. Different from the foregoing embodiments, the system further includes a storage module 80.

The storage module 80 stores one or more lists of scene description information 42. The list of scene description information 42 records a group of scene description information 42 corresponding to specific navigation data 51 after the retrieval operation. Furthermore, the list of scene description information 42 also records the playing sequence of scene section media 43 and the level and node of the navigation data 51 in the tree structure that are recorded in the media playing tree structure.

When acquiring the navigation data 51, the media retrieval module 30 compares the retrieval demand condition 511 included in the navigation data 51 and all lists of scene description information 42 in the storage module 80 to retrieve a target list. The scene description information 42 included in the target list is also the target scene description information 42. Subsequently, the media retrieval module 30 retrieves the scene section media 43 from the media data 41 according to the target list.

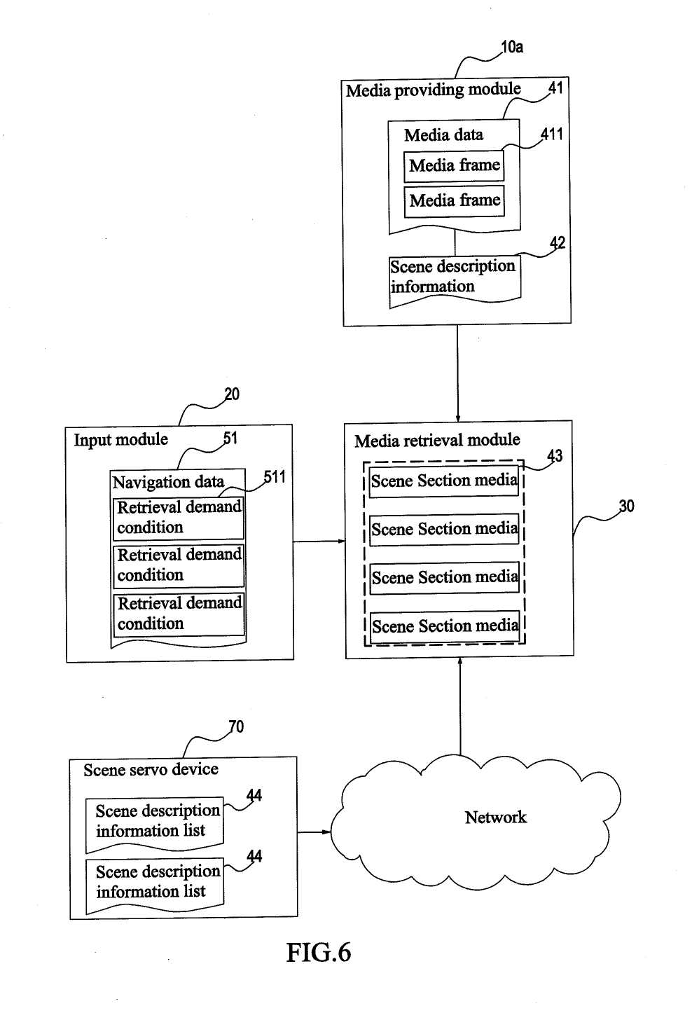

FIG. 6 is a fifth detailed schematic structural view of a media scene playing system according to an embodiment of the present invention. Different from FIG. 4, a scene servo device 70 is connected to a media retrieval module 30, and the connection manner may be wired or wireless. Moreover, lists of scene description information 42 are provided by the scene servo device 70. In this embodiment, the scene servo device 70 may be a third-party device. Furthermore, the scene servo device 70 has the lists of scene description information 42, which may be provided by other users through the same or similar retrieval operation via software or hardware related, similar or equivalent to the retrieval technology disclosed in the present invention.

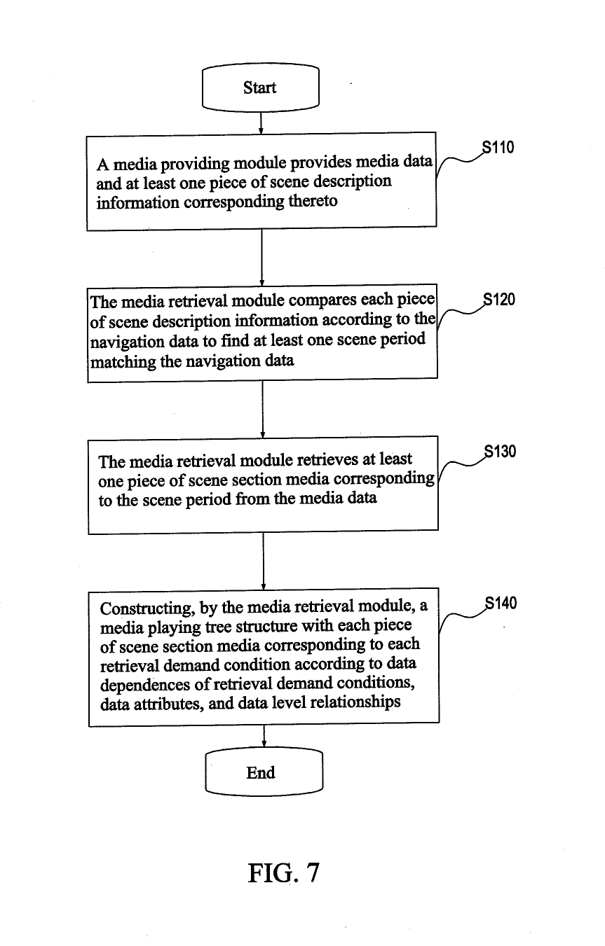

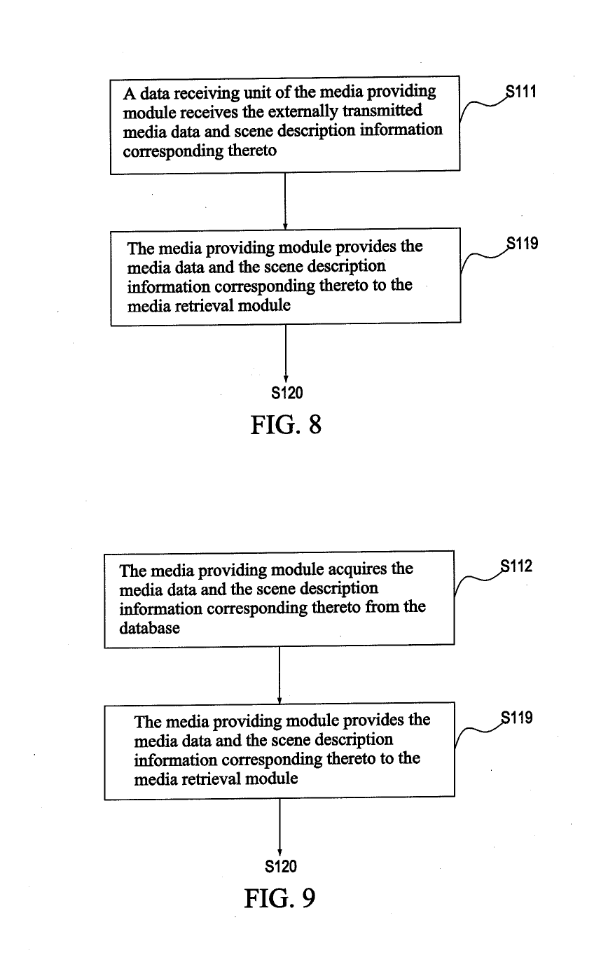

FIG. 7 is a schematic flow chart of a media scene playing method according to an embodiment of the present invention, and FIG. 8 to FIG. 12 are detailed schematic flow charts of the media scene playing method according to the embodiment of the present invention. Please refer to FIG. 1 to FIG. 6 in combination for ease of understanding. The process of the method is as follows.

A media providing module 10 provides media data 41 and at least one piece of scene description information 42 corresponding thereto (Step S110). According to different manners of providing the media data 41 and the scene description information 42, the detailed implementation of this step is also different.

As shown in FIG. 2, the media providing module 10a is connected to an external device 60. The external device 60 provides the media data 41 and the scene description information 42. The media providing module 10 is merely an intermedium for receiving and transferring data. The detailed implementation of this step is as shown in FIG. 8: a data receiving unit 11 of the media providing module 10a receives the externally transmitted media data 41 and scene description information 42 corresponding thereto (Step S111). The media providing module 10a provides the media data 41 and the scene description information 42 corresponding thereto to the media retrieval module 30 (Step S119).

As shown in FIG. 3, the media providing module 10b includes a database 14, which is used for storing the media data 41 and the scene description information 42. The detailed implementation of this step is as shown in FIG. 9: the media providing module 10b acquires the media data 41 and the scene description information 42 corresponding thereto from the database 14 (Step S112), and provides the media data 41 and the scene description information 42 corresponding thereto to the media retrieval module 30 (Step S119).

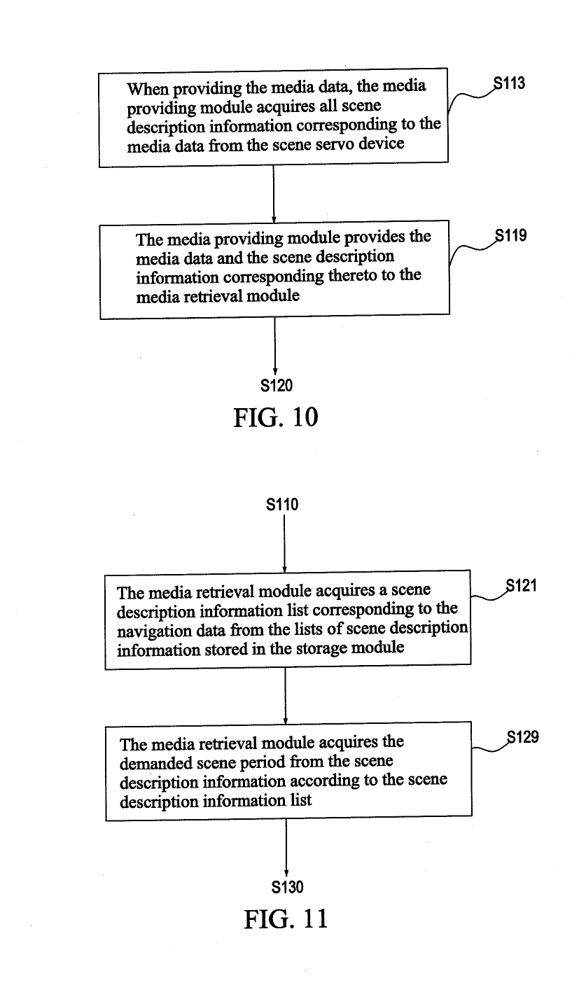

As shown in FIG. 4, the media providing module 10c is connected to a scene servo device 70. The scene servo device 70 stores one or more pieces of scene description information 42. The detailed implementation of this step is as shown in FIG. 10: when providing the media data 41, the media providing module 10c acquires all scene description information 42 corresponding to the media data 41 from the scene servo device 70 (Step S113), and provides the media data 41 and the scene description information 42 corresponding thereto to the media retrieval module 30 (Step S119).

The media retrieval module 30 compares each piece of scene description information 42 according to the navigation data 51 to find at least one scene period 421 matching the navigation data 51 (Step S120). According to different manners of providing the media data 41 and the scene description information 42, the detailed implementation of this step is also different.

As shown in FIG. 5, the media retrieval module 30 is connected to the storage module 80, in which the lists of scene description information 42 are stored. The detailed implementation in this step is as shown in FIG. 11: the media retrieval module 30 acquires a scene description information list 44 corresponding to the navigation data 51 from the lists of scene description information 42 stored in the storage module 80 (Step S121). The media retrieval module 30 acquires the demanded scene period 421 from the scene description information 42 according to the scene description information list 44 (Step S129).

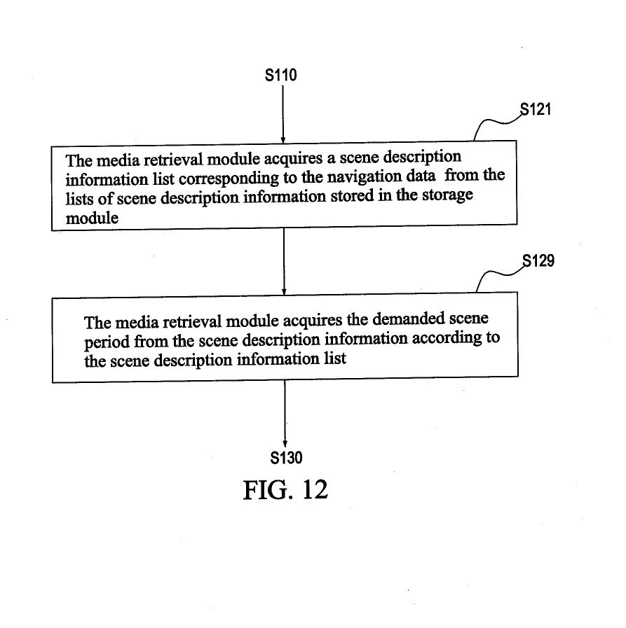

As shown in FIG. 6, a scene servo device 70 is connected to the media retrieval module 30. The detailed implementation in this step is as shown in FIG. 12, but different from the process depicted in FIG. 11, in Step S122, each scene description information list 44 is stored in the scene servo device 70 which is a third-party network device.

The media retrieval module 30 retrieves at least one piece of scene section media 43 corresponding to the scene period 421 from the media data 41 (Step S130). As described above, the media retrieval module 30 compares the retrieval demand condition 511 of the navigation data 51 and each piece of scene description information 42, so as to acquire more than one scene period 421, and then retrieves all scene section media 43 corresponding to the scene period 421 from the acquired media data 41. The manner of retrieving the scene period 421 is described above, which is no longer described herein.

However, the navigation data 51 may include more than one type of retrieval demand condition 511, and may also include multiple different types of retrieval demand conditions 511. The media retrieval module 30 retrieves multiple groups of media frames 411 from the media data 41 according to the retrieval demand conditions 511. Furthermore, the media retrieval module 30 constructs one or more pieces of self-generated media with each piece of retrieved scene section media 43 according to the navigation data 51. Or, the media retrieval module 30 constructs playing media that meets the demands of the user with the scene section media 43 or the group of media frames 411 formed of the scene section media 43.

The method further includes: constructing, by the media retrieval module 30, a media playing tree structure with each piece of scene section media 43 corresponding to each retrieval demand condition 511 according to data dependences of retrieval demand conditions 511, data attributes, and data level relationships (Step S140).

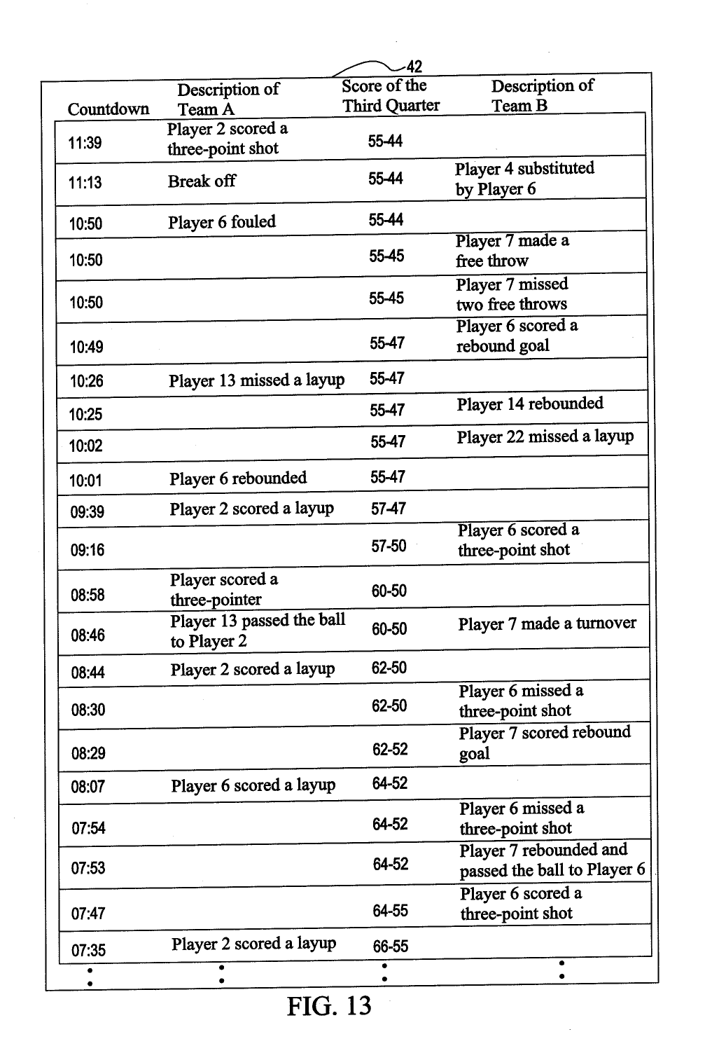

FIG. 13 to FIG. 17 are schematic views of scenarios of media control according to the embodiments of the present invention. Herein, media data 41 is described as recorded images of a basketball game.

FIG. 13 is a schematic view of scene description information according to an embodiment of the present invention, in which a scene instruction and a scene corresponding time of an image of a basketball game are presented.

When a user merely wants to watch “scoring pictures in the third quarter”, this demand condition may be set in navigation data 51. A media retrieval module 30 acquires the countdown of the third quarter “11:39”, “10:50”, “10:49”, “09:39”, “09:16”, “08:58”, “08:44”, “08:29”, “08:07”, “07:47”, “07:35”, and so on and timepoints corresponding to the “scoring scenes in the third quarter”, uses the time before or after the timepoints or the timepoints as the center as the scene periods 421 described above, and then uses the scene periods 421 to retrieve corresponding scene interval images (namely, the scene section media 43 described above) to be played by the relevant playing module. Or, when the demand condition set by the user is “scoring pictures of three-point shots in the third quarter”, the media retrieval module 30 takes the countdown of the third quarter “11:39”, “09:16”, “08:58”, “07:47” and so on and timepoints corresponding to the “scoring scenes of three-point shots in the third quarter”, calculates demanded scene periods 421 based on the timepoints, and then retrieves corresponding scene interval images (namely, the scene section media 43 described above) by using the scene periods 421 to be played by the relevant playing module.

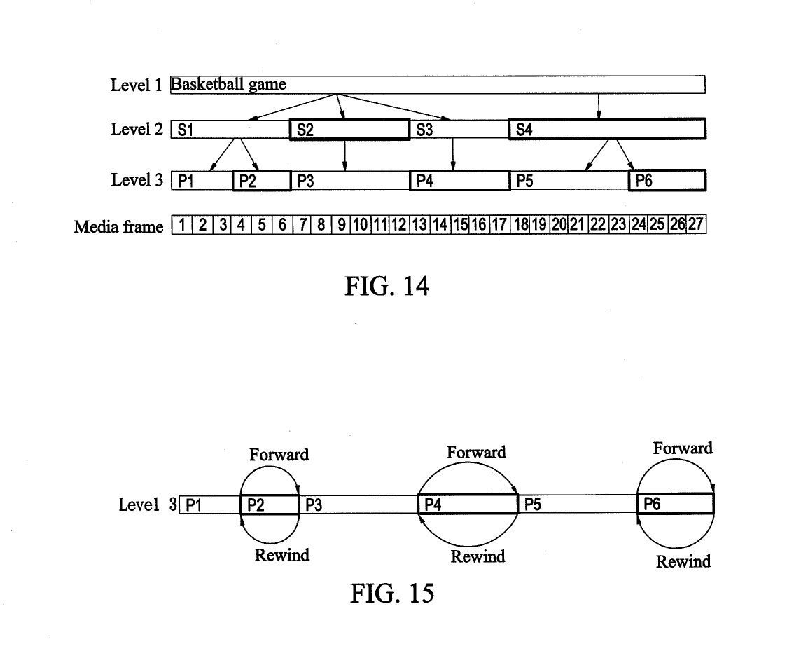

FIG. 14 is a schematic view of media levels according to an embodiment of the present invention. The recorded images of the basketball game can be divided into different image levels. The highest level means the images of the whole game, the next level means the images of all quarters, and the next level means images of close-up shots. The whole images are formed of multiple media frames 411 and/or pieces of scene section media 43, and correspond to the scene description information 42. However, each level can be regarded as the basis for a media division mode.

FIG. 15 is a view of playing scene section media according to an embodiment of the present invention. With the media division mode of the third level as an example, the selected scene section media 43 includes intervals P1, P3 and P5. The relevant playing software, program or module skips to the starting point of the interval P3 and starts to play the interval P3 after the interval P1 is played. In the same way, after the interval P3 is played, the playing software, program or module skips to the starting point of the interval P5 and starts to play the interval P5. During media forwarding, the relevant playing software also performs the forwarding operation interval by interval with the interval as a unit, or directly designates intervals for performing the forwarding operation, for example, forwarding from the interval P1 to the interval P5. On the other hand, during rewinding operation of images, rewinding from the interval P5 to the interval P3 is performed, and then rewinding from the interval P3 to the interval P1 is performed. Or, the relevant playing software directly designates intervals for rewinding, for example, from the interval P5 to the interval P1 or the starting point of the film.

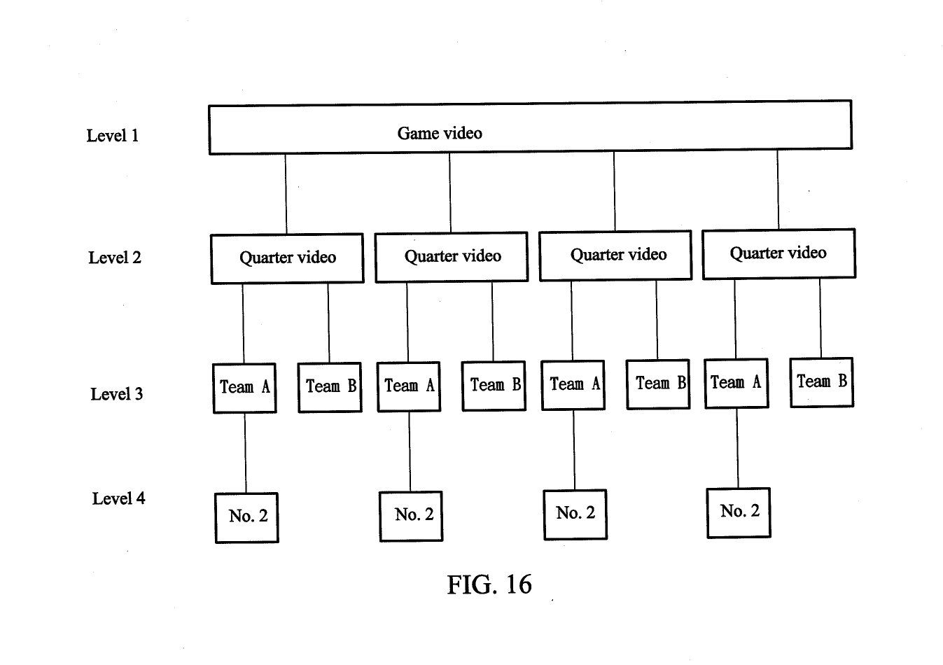

FIG. 16 is a schematic view of a media playing tree structure according to an embodiment of the present invention. Herein, by combining the image levels shown in FIG. 13 and the data dependence relationships of the navigation data 51 or the types of data attributes described above, a media playing tree structure may be constructed with the media frames 411 or the scene description information 42 of the whole recorded images.

The first level of the media playing tree structure is the whole game image. The second level is branches of the first level images, which are the images of both teams. The third level is branches of the second level images, which are close-up images of the two teams in the game. The fourth level is branches of the third level images, which are the close-up shot images of specific players from the two teams in the game.

After a user sets the navigation data 51, the media retrieval module 30 retrieves the demanded media frame 411 from the media data 41 through the media playing tree structure according to the demand condition included in the navigation data 51, so as to form the above self-generated image to be played by a relevant playing module.

However, the media frames 411 retrieved by the media retrieval module 30 do not need to consider the above image level. For example, when a user wants to watch “all scoring pictures of No. 2 player 2 of Team A” and then watch “whole images of the fourth quarter”. The media retrieval module 30 retrieves media frames 411 or scene description information 42 corresponding to “all scoring pictures of No. 2 player of Team A” according to the fourth level structure of the media playing tree structure, retrieves the media frames 411 or scene description information 42 corresponding to the “whole images of the fourth quarter” according to the second level structure of the media playing tree structure, and forms the demanded self-generated images according to the media retrieval manner to be played by the relevant playing module. That is, the media retrieval module 30 may retrieve the scene section media of the same level, different levels or partially same and partially different levels from the media playing tree structure, and integrate the scene section media to play the scene intervals.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A media scene playing system, comprising:
a media providing module, used for providing media data and scene description information corresponding thereto;
an input module, used for inputting navigation data; and
a media retrieval module, used for comparing the navigation data and each piece of scene description information to acquiring at least one scene period matching the navigation data, so as to retrieve at least one piece of scene section media corresponding to the at least one scene period from the media data and play the scene section media.

2. The media scene playing system according to claim 1, wherein the scene description information comprises a plurality of scene playing durations, the navigation data comprises at least one demand timepoint, and the media retrieval module matches the at least one demand timepoint and the scene playing durations, so as to acquire the at least one scene period.

3. The media scene playing system according to claim 1, wherein the scene description information comprises a plurality of scene description instructions and playing durations corresponding thereto, the navigation data comprises at least one piece of scene designation information, and the media retrieval module matches the at least one piece of scene designation information and the scene description instructions, so as to acquire the at least one scene period from the playing durations.

4. The media scene playing system according to claim 1, wherein the media retrieval module retrieves a plurality of media frames from the media data according to the at least one scene period, and combines the media frames to form the at least one piece of scene section media.

5. The media scene playing system according to claim 1, wherein the media providing module comprises a data receiving unit, used for receiving the externally transmitted media data and the scene description information corresponding thereto, so as to provide the media data and the scene description information to the media retrieval module.

6. The media scene playing system according to claim 1, wherein the media providing module comprises a database, used for storing the media data and the scene description information corresponding thereto.

7. The media scene playing system according to claim 1, further comprising a scene servo device connected to the media providing module, wherein when providing the media data, the media providing module acquires the scene description information corresponding to the media data from the scene servo device, so as to provide the scene description information to the media retrieval module.

8. The media scene playing system according to claim 1, further comprising a storage module, wherein the media retrieval module acquires a scene description information list corresponding to the navigation data from the storage module, so as to acquire the at least one scene period from the scene description information list, and acquire the at least one piece of scene section media corresponding to the at least one scene period.

9. The media scene playing system according to claim 1, further comprising a scene servo device connected to the media retrieval module, wherein the media retrieval module acquires a scene description information list corresponding to the navigation data from the scene servo device, so as to acquire the at least one scene period from the scene description information list, and acquire the at least one scene section media corresponding to the at least one scene period.

10. The media scene playing system according to claim 1, wherein the navigation data comprises at least one retrieval demand condition, and the media retrieval module constructs a media playing tree structure with each piece of the scene section media corresponding to each retrieval demand condition according to data dependences of all retrieval demand conditions, data attributes and data level relationships.

11. The media scene playing system according to claim 10, wherein the media retrieval module retrieves the at least one piece of scene section media of the same level, different levels or partially same and partially different levels from the media playing tree structure.

12. The media scene playing system according to claim 1, wherein the navigation data further comprises a media division mode, the media retrieval module divides the media data according to the media division mode, and acquires the corresponding at least one piece of scene section media according to the scene period.

13. A media scene playing method, comprising:
providing, by a media providing module, media data and scene description information corresponding thereto;
comparing, by a media retrieval module, each piece of scene description information according to navigation data to find at least one scene period matching the navigation data; and
retrieving, by the media retrieval module, at least one scene section media corresponding to the at least one scene period from the media data and playing the scene section media.

14. The media scene playing method according to claim 13, wherein the scene description information comprises a plurality of scene playing durations, the navigation data comprises at least one demand timepoint, and the step of comparing, by a media retrieval module, each piece of scene description information according to navigation data to find at least one scene period matching the navigation data comprises:
matching, by the media retrieval module, the at least one demand timepoint and the scene playing durations, so as to acquire the at least one scene period.

15. The media scene playing method according to claim 13, wherein the scene description information comprises a plurality of scene description instructions and playing durations corresponding thereto, the navigation data comprises at least one piece of scene designation information, and the step of comparing, by a media retrieval module, each piece of scene description information according to navigation data to find at least one scene period matching the navigation data comprises:
matching, by the media retrieval module, the at least one piece of scene designation information and the scene description instructions, so as to acquire the at least one scene period from the playing durations.

16. The media scene playing method according to claim 13, wherein the step of comparing, by a media retrieval module, each piece of scene description information according to navigation data to find at least one scene period matching the navigation data comprises:
acquiring, by the media retrieval module, a scene description information list corresponding to the navigation data from a storage module, so as to acquire the at least one scene period from the scene description information list, wherein the scene description information list is stored in the storage module; and
acquiring, by the media retrieval module, the at least one piece of scene section media corresponding to the at least one scene period from the media data.

17. The media scene playing method according to claim 13, wherein the step of comparing, by a media retrieval module, each piece of scene description information according to navigation data to find at least one scene period matching the navigation data comprises:
acquiring, by the media retrieval module, a scene description information list corresponding to the navigation data from a scene servo device, so as to acquire the at least one scene period from the scene description information list, wherein the scene description information list is stored in the scene servo device connected to the media retrieval module; and
acquiring, by the media retrieval module, the at least one piece of scene section media corresponding to the at least one scene period from the media data.

18. The media scene playing method according to claim 13, wherein the navigation data comprises at least one retrieval demand condition, and the method further comprises:
constructing, by the media retrieval module, a media playing tree structure with each target media frame corresponding to each retrieval demand condition according to data dependences of all retrieval demand conditions, data attributes and data level relationships.

19. The media scene playing method according to claim 18, wherein the media retrieval module retrieves the at least one piece of scene section media of the same level, different levels or partially same and partially different levels from the media playing tree structure.

20. A recording medium, storing a program code readable by an electronic device, wherein when the electronic device reads the program code, a media scene playing method is executed, and the method comprises:
providing, by a media providing module, media data and scene description information corresponding thereto;
comparing, by a media retrieval module, each scene description information according to navigation data to find at least one scene period matching the navigation data; and
retrieving, by the media retrieval module, at least one piece of scene section media corresponding to the at least one scene period from the media data.
